(19) United States
(12) Patent Application Publication
(10) Pub. No.: US 2007/0092076 A1
(43) Pub. Date: Apr. 26, 2007

(54) Initialization method and termination method for scrambling transport stream

(75) Inventors: Jiang Fu, San Marcos, CA (US); Xuemin Chen, San Diego, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/256,952

(22) Filed: Oct. 25, 2005

(51) Int. Cl. H04K 1/06

(52) U.S. Cl. 380/37

(57) ABSTRACT

The present invention provides a system, method and apparatus for encrypting/decrypting plain data/cipher text having lengths not equal to a multiple of a data chunk of a block cipher algorithm. The present invention enables plain data having a length that is greater than or less than one data chunk to be encrypted to produce an encrypted version of the plain data having the same length. Further, the present invention enables cipher text having a length that is greater than or less than one data chunk to be decrypted to produce a decrypted version of the cipher text having the same length. Decryption of cipher text having a length that is greater than one data chunk uses two rounds of decryption. A first round of decryption recovers an indirectly encrypted portion. A second round uses the indirectly encrypted portion to completely recover the original plain data.

### BACKGROUND OF THE INVENTION

1. Field of the Invention

The present invention generally relates to encryption systems. More specifically, the present invention provides the encryption/decryption of data/cipher text having lengths that are not equal to a multiple of a data chunk of a block cipher system.

2. Background Art

Encryption systems enable the secure transfer of information. Stream cipher systems operate on one bit or one byte of data at a time. In contrast, block cipher systems operate on a chunk of data (i.e., more than one data bit or byte). Theoretically, block cipher systems are quicker than stream cipher systems. Accordingly, block cipher systems are frequently used to securely transfer large amounts of data.

Padding is used to increase the length of plain data when the length of the plain data is larger than a given data chunk of a block cipher system. Specifically, the size of the plain data is increased to a multiple of the data chunk. The longer, modified plain data is subsequently encrypted to produce an encrypted output. The encrypted output has a length that is larger than the length of the original unpadded data.

Many communication systems or protocols accommodate the transfer of encrypted data that is larger than the original unencrypted data. For such systems, padding enables block cipher systems to operate on plain data of any length. However, some systems and protocols impose inflexible constraints on the length of encrypted data. For example, the encrypted payload of an MPEG transport stream packet must be the same length as the original unencrypted payload. Consequently, traditional padding techniques are not applicable to these less flexible communication systems. As a result, plain data having a length that is not equal to a multiple of the data chunk is left wholly or partially unencrypted when block cipher systems are employed.

### BRIEF SUMMARY OF THE INVENTION

Accordingly, the present invention provides the complete encryption of data having a length not equal to a multiple of a data chunk of a block cipher algorithm. Additionally, the present invention provides the decryption of encrypted data having a length not equal to a multiple of a data chunk of a block cipher algorithm.

The present invention provides a system, method and apparatus for encrypting/decrypting plain data/cipher text having lengths not equal to a multiple of a data chunk of a block cipher algorithm. The present invention enables plain data having a length that is greater than or less than one data chunk to be encrypted to produce a corresponding encrypted version of the plain data having the same length. Further, the present invention enables cipher text having a length that is greater than or less than one data chunk to be decrypted to produce a corresponding decrypted version of the cipher text having the same length. Decryption of cipher text having a length that is greater than one data chunk uses two rounds of decryption. A first round of decryption recovers all but one portion of the original unencrypted data. The first round of decryption also recovers an indirectly encrypted portion. A second round uses the indirectly encrypted portion to recover the remaining portion of the original plain data. As a result, the original data can be reassembled.

Additional features and advantages of the invention will be set forth in the description that follows, and in part will be apparent from the description, or may be learned by practice of the invention. The advantages of the invention will be realized and attained by the structure and particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS/FIGURES

The accompanying drawings illustrate the present invention and, together with the description, further serve to explain the principles of the invention and to enable one skilled in the pertinent art to make and use the invention.

FIG. 1A illustrates a conventional one block cipher operation workflow.

FIG. 1B illustrates a conventional one block decipher operation workflow.

FIG. 2A illustrates a conventional multiple block cipher operation workflow.

FIG. 2B illustrates a conventional multiple block decipher operation workflow.

FIG. 3A illustrates a conventional multiple block cipher operation workflow with Cipher Block Chaining (CBC).

FIG. 3B illustrates a conventional multiple block decipher operation workflow with CBC.

FIG. 4 illustrates a conventional Moving Picture Experts Group (MPEG) transport stream packet.

FIG. 5A illustrates a plain data vector having a length that is greater than one data chunk and not equal to a multiple of the data chunk.

FIG. 5B illustrates a workflow according to an aspect of the present invention for CBC block cipher scrambling of the plain data vector depicted in FIG. 5A.

FIG. 5C illustrates a cipher text vector generated by the workflow depicted in FIG. 5B.

FIG. 6A illustrates a workflow according to an aspect of the present invention for conducting a first round of CBC block cipher descrambling of the cipher text depicted in FIG. 5C.

FIG. 6B illustrates a workflow according to an aspect of the present invention for conducting a second round of CBC block cipher descrambling of the cipher text depicted in FIG. 5C.

FIG. 7A illustrates a workflow according to an aspect of the present invention for block cipher scrambling of plain data having a length that is less than a data chunk of an encrypt engine.

FIG. 7B illustrates a workflow according to an aspect of the present invention for block cipher descrambling of cipher text having a length that is less than a data chunk of a decrypt engine.

FIG. 8A illustrates a workflow according to an aspect of the present invention for ECB block cipher scrambling of the plain data vector depicted in FIG. 5A.

FIG. 8B illustrates a cipher text vector generated according to the ECB encryption workflow depicted in FIG. 8A.

FIG. 9A illustrates a workflow according to an aspect of the present invention for conducting a first round of ECB block cipher descrambling of the cipher text vector depicted in FIG. 8B.

FIG. 9B illustrates a workflow according to an aspect of the present invention for conducting a second round of ECB block cipher descrambling of the cipher text vector depicted in FIG. 8B.

FIG. 10 illustrates an encryption system of the present invention for encrypting data having a length that is not equal to a multiple of a data chunk.

FIG. 11 illustrates an decryption system of the present invention for decrypting encrypted data having a length that is not equal to a multiple of a data chunk.

### DETAILED DESCRIPTION OF THE INVENTION

Encryption algorithms can be divided into two general types: symmetric encryption algorithms and public-key encryption algorithms. Symmetric encryption algorithms use the same key for encryption and decryption. Mathematically, a symmetric encryption system can be described as:
E[k,P]=C (Eq. 1)
D[k, C]=P (Eq. 2)
where P represents unencrypted data (plain data), C represents encrypted data (cipher text), k represents the encryption/decryption key, E represents the encrypt engine and D represents the decrypt engine. Equation (1) shows that the encrypt engine, E, scrambles plain data, P, according to key, k, to produce cipher text, C. Equation (2) shows that the decrypt engine, D, descrambles cipher text, C, according to the same key, k, to reproduce plain data, P.

The encryption algorithm implemented by the encrypt engine E and the decryption algorithm implemented by the decrypt engine D are typically well known or available algorithms. Therefore, the security of a symmetric encryption system is maintained by safeguarding the key k.

Public-key encryption algorithms, or asymmetric encryption algorithms, use a first key for encryption and a second key for decryption.

Mathematically, a public-key encryption system can be described as:
E[k_{PUB},P]=C (Eq. 3)
D[k_{PRV},C]=P (Eq. 4)
where k_{PUB} represents the public key and k_{PRV} represents the private key.

Equation (3) shows that the encrypt engine, E, scrambles plain data, P, according to the public key, kpub, to produce cipher text, C. Equation (4) shows that the decrypt engine, D, descrambles cipher text, C, according to the private key, k_{PRI}, to reproduce plain data, P.

For public-key encryption systems, the public key k_{PUB} is well known or available. Additionally, the encryption algorithm implemented by the encrypt engine E and the decryption algorithm implemented by the decrypt engine D are typically well known or available algorithms. Therefore, anyone can use the public key k_{PUB} to encrypt plain data. However, only users with knowledge of the private key k_{PRV} can decipher encrypted data.

Theoretically, symmetric key algorithms are faster than public-key algorithms. Consequently, symmetric key systems are more commonly used to encrypt/decrypt large amounts of data.

Symmetric key algorithms can be subdivided into two categories: stream cipher systems and block cipher systems. The encrypt and decrypt engines of a stream cipher system operate on one bit or one byte of data at a time. In contrast, the encrypt and decrypt engines of a block cipher system operate on a group of bits or a chunk of data at a time. The length or size of the data chunk depends on a selected algorithm. For example, the Data Encryption Standard (DES) algorithm and the Triple DES (3DES) algorithm operate on 64 bit data chunks (i.e., 8 byte data chunks) while the Advanced Encryption Standard (AES) algorithm operates on 128 bit data chunks (i.e., 16 byte data chunks).

The encrypt engine of a block cipher system can directly operate on plain data having a length equal to a multiple of a given data chunk. If the input to the encrypt engine has a length that is not a multiple of the data chunk, then the plain data is padded to increase length. Specifically, additional bits are appended to the tail of the original plain data until the total length of the plain data is exactly equal to a multiple of the data chunk. This enables the encrypt engine to operate on the plain data. The format of the padding is user-definable. For example, zero-padding or one-padding can be used.

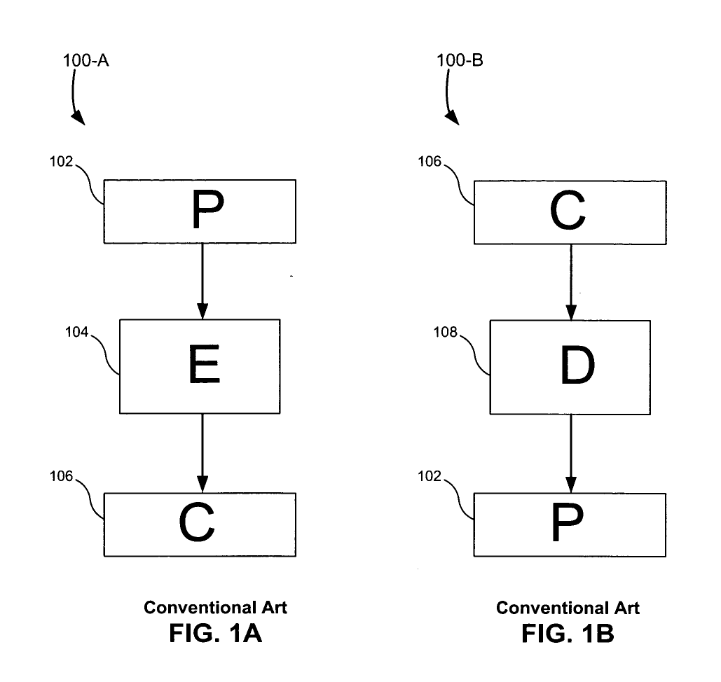

FIG. 1A illustrates a conventional one block cipher operation workflow 100-A. As shown in FIG. 1A, plain data 102 is encrypted by encrypt engine 104 to produce cipher text 106. The length of the plain data 102 is equal to the data chunk of the encrypt engine 104. The length of the cipher text 106 is also equal to the data chunk of the encrypt engine 104.

FIG. 1B illustrates a conventional one block decipher operation workflow 100-B. As shown in FIG. 1B, the cipher text 106 is decrypted by decrypt engine 108 to reproduce the plain data 102. The encrypt engine 104 and the decrypt engine 108 are controlled by the same key. The data chunk size of the encrypt engine 104 and the data chunk size of the decrypt engine 108 are inherently equal.

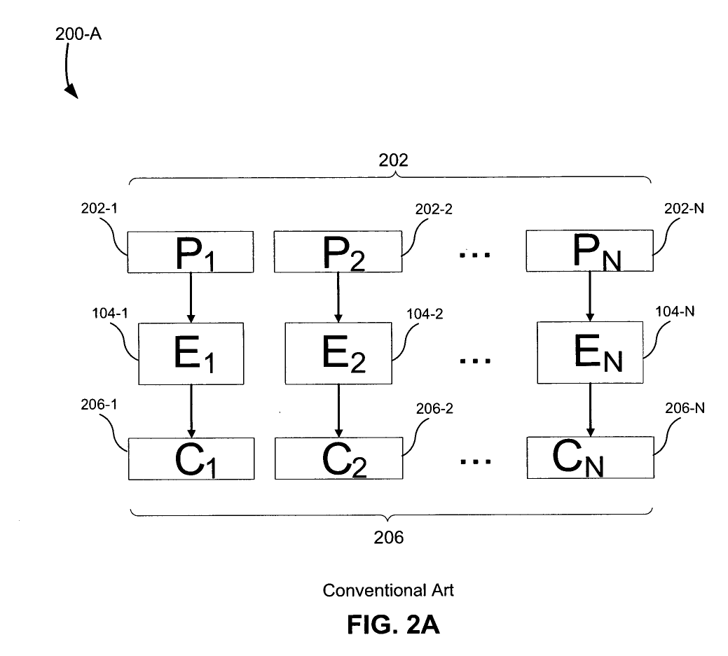

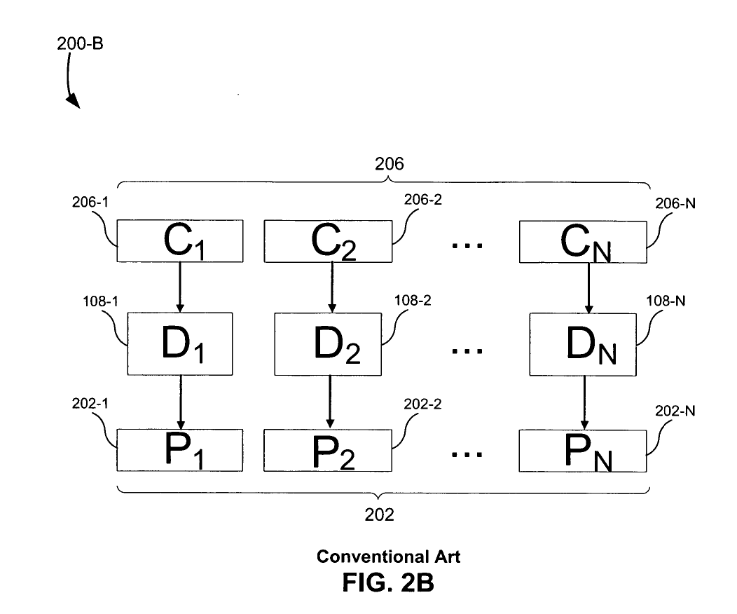

The conventional encrypt operation illustrated in FIG. 1A is implemented multiple times when the data to be encrypted is larger than one data chunk. FIG. 2A illustrates a conventional multiple block cipher operation workflow 200-A. Plain data 202 is larger than one data chunk. Specifically, the plain data 202 comprises N equal-sized portions (shown as parsed plain data portions 202-1 through 202-N). The length of each plain data portion 202-1 through 2020-N is equal to one data chunk. The plain data portions 202-1 through 202-N are encrypted by respective encrypt engines 104-1 through 104-N to produce corresponding cipher text portions 206-1 through 206-N. The cipher text portions 206-1 through 206-N are concatenated to produce cipher text 206. The cipher text 206 can be considered a cipher text string or vector. The total length of the cipher text 206 is equal to the total length of the plain data 202.

FIG. 2B illustrates a conventional multiple block decipher operation workflow 200-B. The cipher text 206 is larger than one data chunk.

Specifically, the cipher text 206 comprises N equal-sized portions (shown as parsed cipher text portions 206-1 through 206-N). The length of each cipher text portion 206-1 through 206-N is equal to one data chunk. The cipher text portions 206-1 through 206-N are decrypted by respective decrypt engines 108-1 through 108-N to reproduce the corresponding plain data portions 202-1 through 202-N. The recovered plain data portions 202-1 through 202-N are concatenated to reproduce the plain data 202. The plain data 202 can be considered a plain data string or vector.

The conventional multiple block cipher and decipher operations illustrated by FIGS. 2A and 2B, respectively, depict an Electronic Codebook (ECB) mode of operation. With ECB, each data chunk is independently processed. As shown in FIG. 2A, each plain data portion 202-1 through 202-N is independently encrypted. That is, the encryption of a plain data portion (e.g., the plain data portion 202-2) does not depend on the encryption of any other plain data portion (e.g., the prior plain data portion 202-1). Likewise, as shown in FIG. 2B, each cipher text portion 206-1 through 206-N is independently decrypted. That is, the decryption of a cipher text portion (e.g., the cipher text portion 206-2) does not depend on the decryption of any other cipher text portion (e.g., the cipher text portion 206-1).

ECB mode enables straightforward parallelization of the encrypt engines 104-1 through 104-N and the decrypt engines 108-1 through 108-N for increased encryption and decryption performance, respectively. However, with ECB mode, a given plain data portion always maps to the same cipher text portion. This characteristic can reduce the security of an ECB block cipher system.

To enhance security, Cipher Block Chaining (CBC) can be added to the conventional encrypting and decrypting operations illustrated in FIGS. 2A and 2B, respectively. With CBC, each data chunk is not processed independently. Specifically, with the exception of the first block of plain data, the processing of each block of plain data is dependent upon the processing of a prior block of plain data.

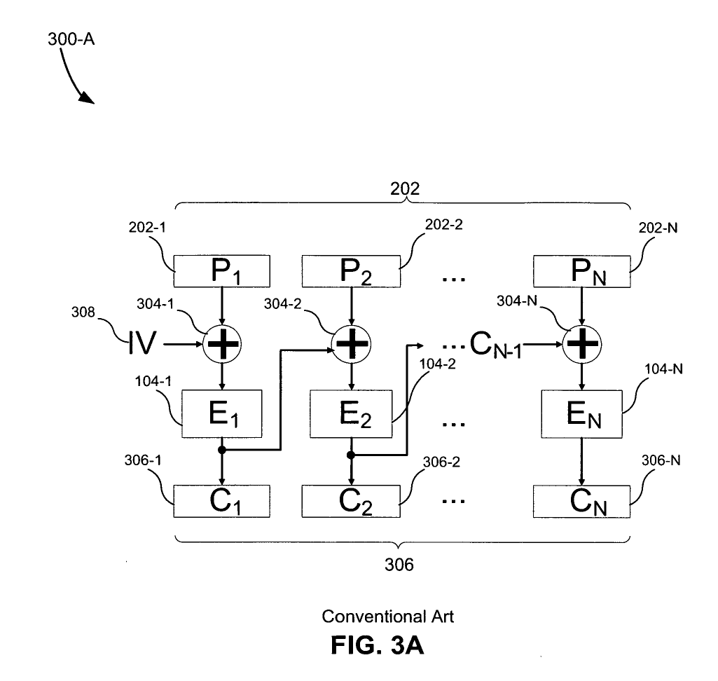

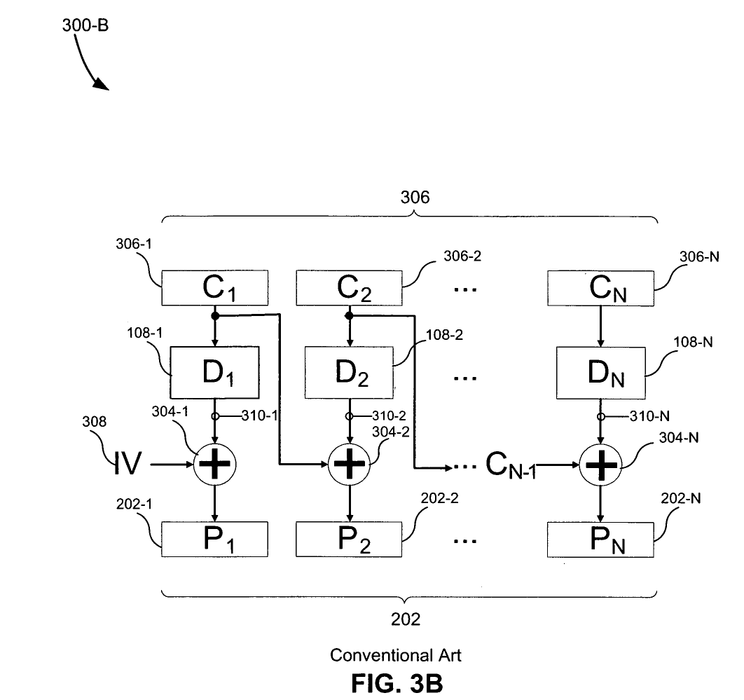

FIG. 3A illustrates a conventional multiple block cipher operation workflow 300-A with CBC. As shown in FIG. 3A, the parsed plain data portions 202-1 through 202-N are used to generate corresponding cipher text portions 306-1 through 306-N. Prior to encryption, each plain data portion 202-2 through 202-N is XORed with the output of the previous encryption operation. For example, the plain data portion 202-2 is first XORed with the cipher text portion 306-1 and then encrypted by the encrypt engine 104-2 to produce the cipher text portion 306-2. The first plain data portion 202-1 is XORed with a user defined initial vector (IV) 308. The IV 308 is a known bit string. XOR circuits 304-1 through 304-N perform the XOR operations discussed above. The resulting cipher text portions 306-1 through 306-N are concatenated to produce cipher text 306. The cipher text 306 can be considered a cipher text string or vector.

FIG. 3B illustrates a conventional multiple block decipher operation workflow 300-B with CBC. As shown in FIG. 3B, the parsed cipher text portions 306-1 through 306-N are used to reproduce the corresponding plain data portions 202-1 through 202-N. The cipher text portions 306-1 through 306-N are decrypted to produce intermediate output portions 310-1 through 310-N. Each intermediate output portion 310-2 through 310-N is XORed with the input of the previous decryption operation. For example, the cipher text portion 306-2 is decrypted using decrypt engine 108-2 to produce the intermediate output portion 310-2. The intermediate output portion 310-2 is then XORed with the cipher text portion 306-1 to reproduce the plain data portion 202-2. The first intermediate output portion 310-1 is XORed with the initial vector 308. The plain data portions 202-1 through 202-N are concatenated to reproduce plain data 202.

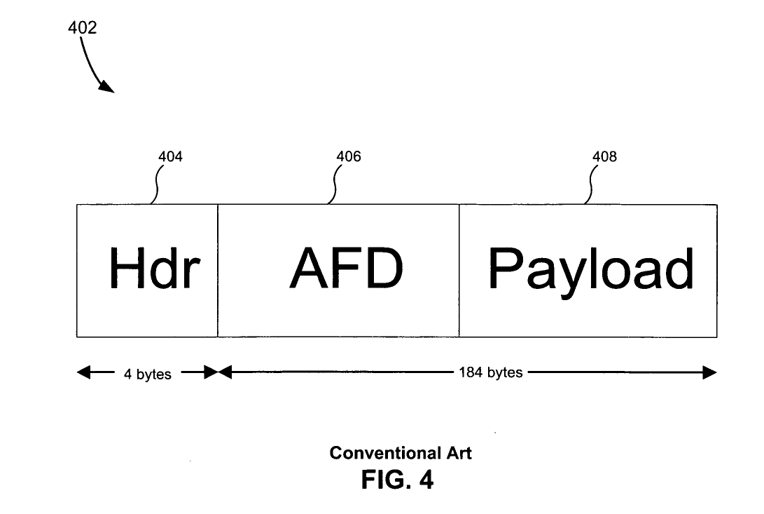

FIG. 4 illustrates a conventional Moving Picture Experts Group (MPEG) transport stream packet 402. The conventional MPEG transport stream packet 402 has a total length of 188 bytes. The conventional MPEG transport stream packet 402 includes a 4 byte packet header 404, an optional adaptation field (AFD) 406 and/or an optional payload 408. The AFD 406 and the payload 408 are variable length fields. An “adaptation field control” flag is a 2 bit field located within the packet header 404. The adaptation field control flag specifies whether the conventional MPEG transport stream packet 402 contains an AFD 406, a payload 408 or both. If an AFD 406 is included within the conventional MPEG transport stream packet 402, then a header within the AFD 406 specifies a length or size of the AFD 406. In turn, the length of an included payload 408 is determinable.

The multiple MPEG standards (e.g., MPEG-2 and MPEG-4) include rules for scrambling data at the transport stream level. Specifically, the MPEG standards specify that only the payload 408 portion of the conventional MPEG transport stream packet 402 can be encrypted. The “transport scrambling control” flag is a 2 bit field located within the packet header 404. The transport scrambling control flag specifies whether the conventional MPEG transport stream packet 402 contains encrypted data or plain data within the payload 408. If the payload 408 carries plain data, then the transport scrambling control flag is set to “0.” If the payload 408 carries encrypted data, then the transport scrambling control flag is set to a non-zero value such as “1”, “2” or “3.” The chosen non-zero value is user-definable.

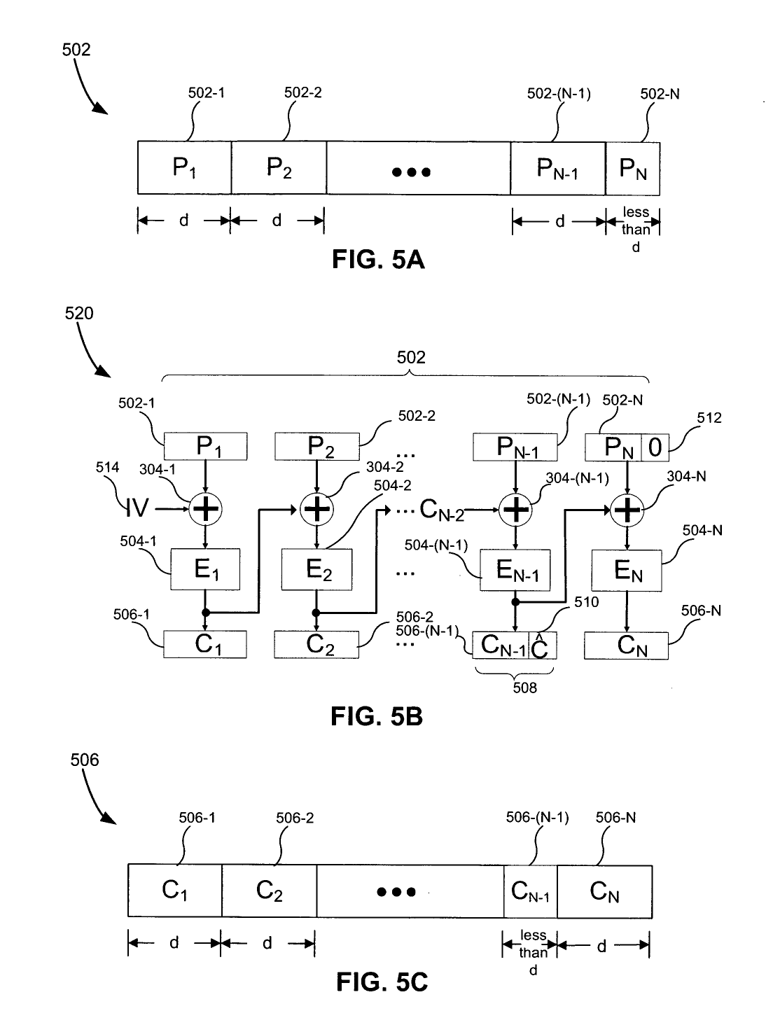

FIG. 5A illustrates a plain data string or vector 502. The plain data vector 502 can form the payload 408 of the conventional MPEG transport stream packet 402 depicted in FIG. 4. As shown in FIG. 5A, the plain data vector 502 comprises N plain data portions 502-1 through 502-N. The lengths of each plain data portion 502-1 through 502-(N−1) are equal to one data chunk, d. Accordingly, the plain data portion 502-1 through 502-(N−1) can be considered complete data portions 502-1 through 502-(N−1). The length of the plain data portion 502-N, however, is less than one data chunk. Therefore, the total length of the plain data vector 502 is greater than one data chunk but is not equal to a multiple of the data chunk. The plain data portion 502-N can be considered a partial data portion.

As previously mentioned, when the length of plain data is not a multiple of a data chunk of an encrypt engine of a block cipher system, padding is typically used to increase the length of the plain data. For example, when the total length of plain data is less than one data chunk, padding can be added such that the total length of the plain data is exactly equal to one data chunk. Alternatively, when the total length of the plain data is greater than one data chunk but not equal to a multiple of the data chunk, padding can be added such that the total length of the plain data is exactly equal to a multiple of the data chunk.

Padding increases the length of the plain data such that the resulting encrypted plain data is larger or longer than the original, unencrypted plain data. Many cryptography applications, such as secure email or secure document transfer, are flexible and allow the length of the resulting cipher text to be longer than the length of the original plain data. However, protocols governing the transmission of MPEG packets at the transport stream level are inflexible. Because the length of each transport stream packet is fixed (188 bytes), cipher text length must be exactly the same length as unpadded plain text. Therefore, conventional padding and encrypting operations cannot be used to encrypt the plain data vector 502.

As an alternative to padding, the plain data portions 502-1 through 502-(N−1) can be encrypted by corresponding block cipher engines and the plain data portion 502-N can be left unencrypted. In doing so, a large portion of the plain data vector 502 can be encrypted while ensuring length remains constant. However, the plain data portion 502-N is transmitted in an unsecured state. In turn, the integrity of the block cipher system may be compromised. Therefore, what is needed is a mechanism by which plain data having a length not equal to a multiple of a data chunk of a block cipher engine can be fully encrypted without increasing the resulting length. Further, what is needed is a mechanism by which cipher text not equal to a multiple of a data chunk of a block decipher engine can be decrypted to reproduce plain data without any loss of information. Additionally, these encryption and decryption mechanism should work across multiple encryption algorithms and variable modes of operation.

FIG. 5B illustrates a workflow 520 for CBC block cipher scrambling of plain data having a length that is longer than a data chunk and not equal to a multiple of the data chunk, in accordance with an aspect of the present invention. Specifically, FIG. 5B illustrates the multiple block CBC mode encryption of the plain data vector 502 depicted in FIG. 5A.

As shown in FIG. 5B, the parsed plain data portion 502-1 is XORed with an initial vector 514 and then encrypted using encrypt engine 504-1 to produce corresponding cipher text portion 506-1. The initial vector 514 is a user-defined, known bit string. The parsed plain data portion 502-2 is XORed with the output of the previous encryption operation (i.e., the cipher text portion 506-1) and then encrypted using encrypt engine 504-2 to produce cipher text portion 506-2. This process is continued such that each parsed plain data portion 502-1 through 502-N is used to produce a corresponding cipher text portion.

To produce the corresponding cipher text portion 506-N, the plain data portion 502-N is first padded to increase the length of the plain data portion 502-N. Specifically, a padding portion 512 is appended to the plain data portion 502-N such that the total length of the plain data portion 502-N and the padding portion 512 is equal to one data chunk. As shown in FIG. 5B, the padded portion is attached to the right most bits of the plain data portion 502-N. The padded portion can comprise a known bit string such as, for example, a string of “0” bits.

The second to last cipher text portion 508 is divided into two sections:

a relevant section 506-(N−1) and an extraneous section 510. The second to last cipher text portion 508 corresponds to the input portion 502-(N−1). Further, the input portion 502-(N−1) can be considered the input portion preceding the partial input portion 502-N. The length of the relevant section 506-(N−1) is equal to a length of the plain data portion 502-N. A length of the extraneous section 510 is equal to a length of the padding portion 512. The relevant section 506-(N−1) and the extraneous section 510 are both XORed with the plain data portion 502-N and the padding portion 512 to produce, after encryption by encrypt engine 504-N, the corresponding cipher text portion 506-N. The relevant section 506-(N−1) can be considered the corresponding cipher text portion of the plain data portion 502-(N−1). As shown in FIG. 5B, the extraneous portion is composed of the right most bits of the output 508.

FIG. 5C illustrates the cipher text vector 506 generated by the workflow 520 depicted in FIG. 5B. As shown in FIG. 5C, the extraneous portion 510 of the second to last cipher text portion 508 is not used to form the encrypted payload or cipher text 506. That is, all cipher text portions except the extraneous portion 510 of the cipher text portion 508 are concatenated to produce an encrypted version of the plain data vector 502. Therefore, the extraneous portion 510 is ignored or discarded when generating the encrypted payload 506. By removing the extraneous portion 510, the total length of the cipher text vector 506 is equal to the total length of the plain data vector 502.

The workflow 520 depicted in FIG. 5B therefore fully encrypts the plain data vector 502 without increasing the length of the resulting cipher text vector 506.

The workflow 520 can be used to fully encrypt any type of plain data such as, for example, MPEG data. Further, the encrypt engines 504-1 through 504-N can implement any type of block cipher algorithm. For example, the encrypt engines 504-1 through 504-N can be DES, 3DES or AES encrypt engines.

FIG. 5B illustrates the workflow 520 as a parallel operation implemented by using multiple parallel encrypt engines 504-1 through 504-N.

This enables the plain data portions 502-1 through 502-N to be encrypted in parallel. Alternatively, a single encrypt engine (e.g., the encrypt engine 504-1) can be used to iteratively encrypt the parsed plain data portions 502-1 through 502-N. In doing so, the plain data portions 502-1 through 502-N are serially encrypted.

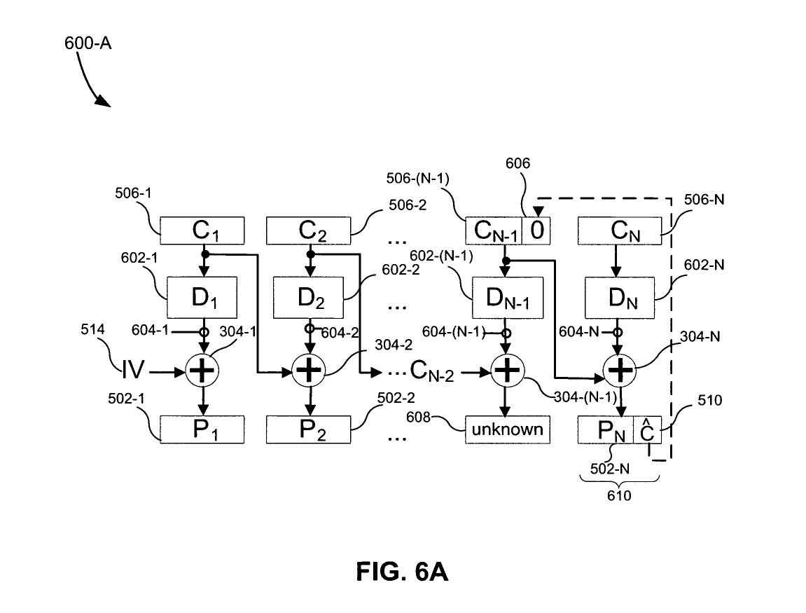

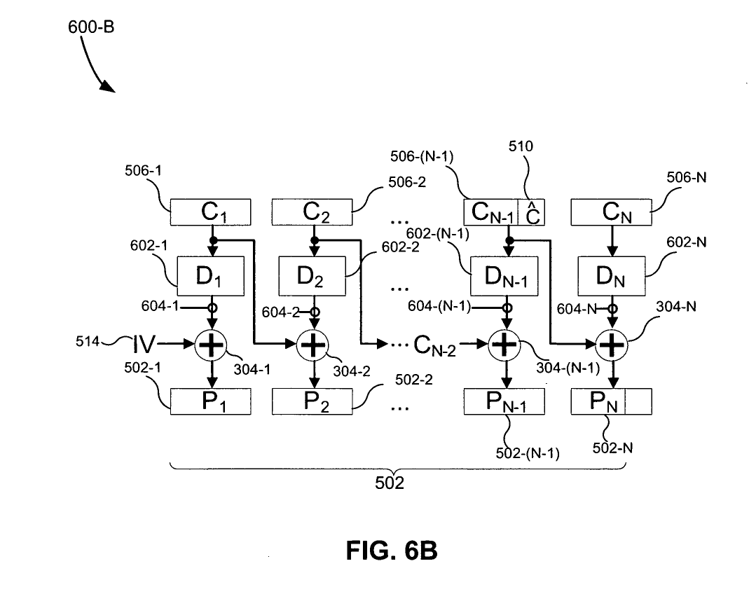

FIG. 6A illustrates a workflow 600-A according to an aspect of the present invention for conducting a first round of CBC block cipher descrambling of cipher text having a length that is longer than a data chunk and not equal to a multiple of the data chunk. Specifically, FIG. 6A illustrates a first round of the multiple block CBC mode decryption of the cipher text vector 506 depicted in FIG. 5C.

As shown in FIG. 6A, the parsed cipher text portion 506-1 is decrypted using decrypt engine 602-1 to produce an intermediate output portion 604-1.

The intermediate output portion 604-1 is XORed with the IV 514 to reproduce the plain data portion 502-1. The parsed cipher text portion 506-2 is decrypted using decrypt engine 602-2 to produce intermediate output portion 604-2. The intermediate output portion 604-2 is XORed with the input from the previous decryption operation (i.e., the cipher text portion 506-1) to reproduce the plain data portion 502-2. This process is continued for each cipher text portion comprising the cipher text 506.

During the first round of decryption, padding is added to the cipher text portion 506-(N−1). Specifically, a padded portion 606 is appended to the cipher text portion 506-(N−1) such that the total length of the cipher text portion 506-(N−1) and the padded portion 606 is equal to one data chunk of the decrypt engine 602-(N−1). The length and composition of the padded portion 606 that of the padded portion 512. The length of the padded portion 606 can be determined since the length of the cipher text vector 506 is known.

The cipher text portion 506-(N−1) and appended padded portion 606 are decrypted using the decrypt engine 602-(N−1) to produce intermediate output portion 604-(N−1). The intermediate output portion 604-(N−1) is XORed with the input of the previous decryption operation (i.e., the plain data portion 506-(N−2)) to produce an unknown intermediate result 608. The unknown result 608 is an irrelevant portion not equal to the plain data portion 502-(N−1).

The last step of the first round of the decryption operation depicted in FIG. 6A involves the decryption of the cipher text portion 506-N. The cipher text portion 506-N is decrypted using decrypt engine 602-N to produce intermediate output portion 604-N. The intermediate output portion 604-N is XORed with the input of the previous decryption operation (i.e., the plain data portion 506-(N−1) and the padded portion 606) to produce an output 610. The output 610 includes the reproduced plain data portion 502-N and the extraneous portion 510. The output 610 can be considered the output portion succeeding the irrelevant output portion 608. As shown in FIG. 6A, the first round of decryption is concluded when the extraneous portion 510 is used to overwrite the padded portion 606. At the conclusion of the first round, each portion of the plain data vector 502 is recovered with the exception of the plain data portion 502-(N−1).

FIG. 6B illustrates a workflow 600-B according to an aspect of the present invention for conducting a second round of CBC block cipher descrambling of cipher text having a length that is longer than a data chunk and not equal to a multiple of the data chunk. Specifically, FIG. 6B illustrates a second round of the multiple block CBC mode decryption of the cipher text vector 506. The workflow 600-B is a continuation of the workflow 600-A depicted in FIG. 6A.

The second round of decryption is used to recover the plain data portion 502-(N−1). As shown in FIG. 6B, the extraneous portion 510 is appended to the cipher text portion 506-(N−1). Together, the extraneous portion 510 and the cipher text portion 506-(N−1) are decrypted by the decrypt engine 602-(N−1) to reproduce the intermediate output portion 604-(N−1). The intermediate output portion 604-(N−1) is XORed with the input from the previous decryption operation (i.e., the plain data portion 506-(N−2)) to reproduce 502-(N−1). The plain data portions 502-1 through 502-N are then concatenated to produce the plain data vector 502 as depicted in FIG. 5A.

The combination of the cipher text portion 506-(N−1) and the extraneous portion 510 is used to reproduce the plain data portion 502-(N−1).

The extraneous portion 510, however, is not available to the decrypt engine 602-(N−1) until the conclusion of the first round of decryption. Specifically, the extraneous portion 510 is reproduced or recovered by decrypting the last cipher text portion 506-N. A second round of decryption is therefore used to decrypt the combination of the cipher text portion 506-(N−1) and the recovered extraneous portion 510. Since all other portions of the plain data vector 502 are recovered in the first round of decryption, it is not necessary to conduct any other decryption operations other than decryption of the cipher text portion 506-(N−1) and the extraneous portion 510 in the second round.

The extraneous portion 510 is not directly carried in the encrypted payload 506. The extraneous portion 510, however, is indirectly carried by the encryption payload 506. The extraneous portion 510 is indirectly carried due to the XORing of the cipher text portion 508 with the plain data portion 502-N and padded portion 512 as shown in FIG. 5B. The first round of decryption is used to recover the extraneous portion 510. Once recovered, a second round of decryption is used to recover the second to last plain data portion 502-(N−1).

The workflows 600-A and 600-B can be used to fully decrypt any type of cipher text such as, for example, encrypted MPEG data. Together, the workflows 600-A and 600-B provide a termination scheme for data scrambled according to the workflow 520 depicted in FIG. 5B. Further, the decrypt engines 602-1 through 602-N can implement any block cipher algorithm such as, for example, DES, 3DES or AES such that they correspond to the block cipher algorithm used by the encrypt engines 504-1 through 504-N illustrated in FIG. 5B.

FIGS. 6A and 6B illustrate respective workflows 600-A and 600-B as parallel operations implemented by using multiple parallel decrypt engines 602-1 through 602-N. This enables the cipher portions 506-1 through 506-N to be decrypted in parallel. Alternatively, a single decrypt engine (e.g., the encrypt engine 602-1) can be used to iteratively decrypt the cipher text portions 506-1 through 506-N in a first and second round of decryption. In doing so, the cipher text portions 506-1 through 506-N are serially decrypted.

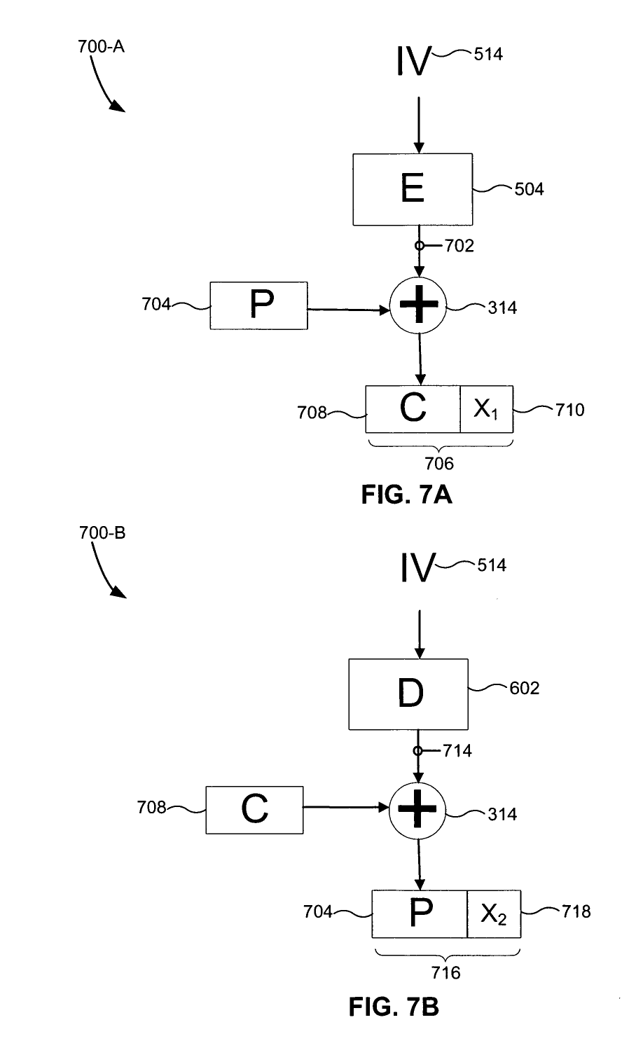

The CBC encryption workflow 520 illustrated in FIG. 5B can be modified to accommodate the encryption of plain data having a length less than one data chunk. Specifically, FIG. 7A illustrates a workflow 700-A for block cipher scrambling of plain data having a length that is less than a data chunk of an encrypt engine, in accordance with an aspect of the present invention. The workflow 700-A depicts the solitary case of CBC mode encryption.

As shown in FIG. 7A, the encrypt engine 504 receives the initial vector 514. The length of the initial vector is equal to the length of the data chunk of the encrypt engine 504. The encrypt engine 504 encrypts the initial vector 514 to produce an intermediate output 702. The length of the intermediate output is also equal to the data chunk of the encrypt engine 504. The intermediate output is XORed with plain data 704 to produce an output 706. The length of the plain data 704 is less than the data chunk of the encrypt engine. Therefore, the length of the plain data 704 is less than the length of the intermediate output 702.

The output 706 includes a first cipher text portion 708 and a second portion 710. The cipher text 708 is considered an encrypted version of the plain data 704. The length of the cipher text 708 is equal to the length of the plain data 704. The second portion 710 is an irrelevant or extraneous portion of the cipher text 706. Consequently, the second potion 710 is ignored or discarded. The length of the second portion 710 is equal to a difference in the lengths of the plain data 704 and the initial vector 514.

The CBC encryption workflow 520 and the CBC decryption workflows 600-A and 600-B represent a termination method for encrypting data. That is, the portion of plain data that is less than the data chunk is positioned at the end of the plain data string 502 (i.e., the plain data portion 502-N). Correspondingly, the portion of cipher text created that is less than the data chunk is positioned just before the end of the cipher text vector 506 (i.e., the relevant section 506-(N−1)).

It is to be appreciated by one skilled in the relevant art(s) from the discussion herein that the CBC encryption workflow 520 and the CBC decryption workflows 600-A and 600-B can be modified to accommodate an initialization method for encrypting data. Specifically, the portion of plain data that is less than the data chunk can be positioned near the front of the plain data string 502 (i.e., the plain data portion 502-2), with all other plain data portions being complete data portions. Correspondingly, the portion of cipher text created that is less than the data chunk is positioned at the front of the cipher text vector 506 (e.g., the portion 506-1), with all other cipher text portions being full portions. The encryption and decryption described above is accordingly adjusted to support placement of the partial input portion such a position.

Further, it is to be appreciated by one skilled in the relevant art(s) from the discussion herein that the CBC encryption workflow 520 and the CBC decryption workflows 600-A and 600-B can accommodate a “generic” method for encrypting data. Specifically, the portion of plain data that is less than the data chunk can placed into any position from near the front of the plain data string 502 (i.e., the plain data portion 502-2) to the end of the plain data string 502 (i.e., the plain data portion 502-N). Accordingly, the portion of cipher text created that is less than the data chunk is correspondingly generated anywhere from the front of the cipher text vector 506 (e.g., the portion 506-1) to just before the end of the cipher text vector 506 (i.e., the relevant section 506-(N−1)). The plain data vector 502 can be parsed in any fashion (with the cipher text vector 506 parsed in a corresponding manner) to support this generic mode of encryption/decryption.

The CBC decryption workflows 600-A and 600-B illustrated in FIGS. 6A and 6B, respectively, can be modified to accommodate the decryption of cipher text that is shorter than one data chunk. Specifically, FIG. 7B illustrates a workflow 700-B for block cipher descrambling of cipher text having a length that is less than a data chunk of a decrypt engine, in accordance with an aspect of the present invention. The workflow 700-B depicts the solitary case of CBC mode decryption.

As shown in FIG. 7B, the decrypt engine 602 receives the initial vector 514. The length of the initial vector is equal to the length of the data chunk of the decrypt engine 602. The decrypt engine 502 decrypts the initial vector 514 to produce an intermediate output 714. The length of the intermediate output 714 is equal to the data chunk of the decrypt engine 602. The intermediate output 714 is XORed with cipher text 708 to produce an output 716.

The output 716 includes a first reproduced plain data portion 704 and a second portion 718. The second portion 718 is an irrelevant or extraneous portion of the output 716. Consequently, the second potion 718 is ignored or discarded. The length of the second portion 718 is equal to a difference in the lengths of the cipher text 708 and the initial vector 514.

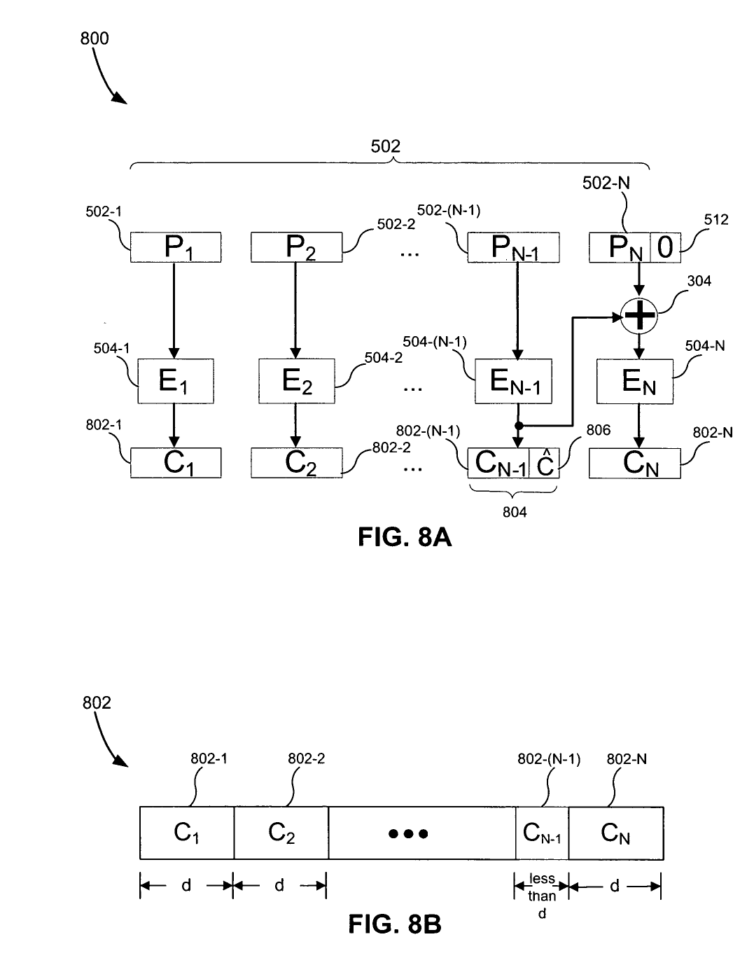

The CBC encryption workflow 520 illustrated in FIG. 5B can also be modified to accommodate an ECB mode of encryption. FIG. 8A illustrates a workflow 800 according to an aspect of the present invention for ECB block cipher scrambling of plain data having a length that is longer than a data chunk and not equal to a multiple of the data chunk. Specifically, FIG. 8A illustrates the multiple block ECB mode encryption of the plain data vector 502.

As shown in FIG. 8A, the parsed plain data portions 502-1 through 502-(N−1) are encrypted independently to produce corresponding cipher text portions 802-1 through 802-(N−1). To produce the corresponding cipher text portion 802-N, the plain data portion 502-N is first padded to increase the length of the plain data portion 502-N. Specifically, the padding portion 512 is appended to the plain data portion 502-N such that the total length of the plain data portion 502-N and the padding portion 512 is equal to one data chunk.

The cipher text portion 804 includes a relevant portion 802-(N−1) and an extraneous portion 806. A length of the relevant cipher text portion 802-(N−1) is equal to the length of the plain data portion 502-N. A length of the extraneous portion 806 is equal to a length of the padding portion 512. The relevant portion 802-(N−1) and the extraneous portion 806 are both XORed with the plain data portion 502-N and the padding portion 512 to produce, after encryption by the encrypt engine 504-N, the corresponding cipher text portion 802-N. In essence, the cipher text portion 802-N is generated by mimicking a CBC mode of encryption.

FIG. 8B illustrates the cipher text vector 802 generated by the workflow 800 depicted in FIG. 8A. The cipher text vector 802 is a concatenation of the cipher text portions 802-1 through 802-N. As shown in FIG. 8B, the extraneous portion 806 of the second to last cipher text portion 804 is not used to form the encrypted payload or cipher text 802. That is, all cipher text portions except the extraneous portion 806 of the cipher text portion 804 are concatenated to produce an encrypted version of the plain data vector 502. Therefore, the extraneous portion 806 is ignored or discarded when generating the encrypted payload 506. By removing the extraneous portion 806, the total length of the cipher text vector 802 is equal to the total length of the plain data vector 502. The workflow 800 depicted in FIG. 8A therefore fully encrypts the plain data vector 502 without increasing the length of the resulting cipher text vector 802.

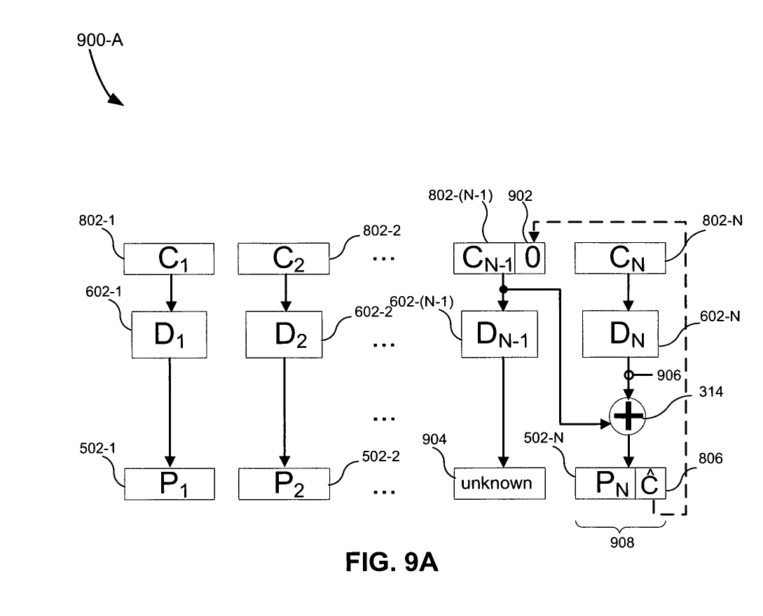

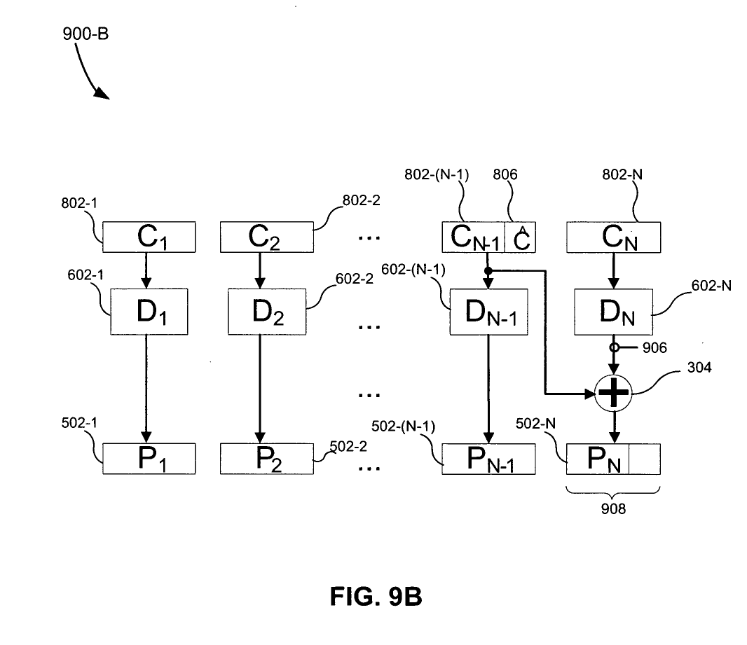

The CBC decryption workflows 600-A and 600-B illustrated in FIG. 6A and 6B, respectively, can be modified to accommodate an ECB mode of decryption. FIG. 9A illustrates a workflow 900-A according to an aspect of the present invention for conducting a first round of ECB block cipher descrambling of cipher text having a length that is longer than a data chunk and not equal to a multiple of the data chunk. Specifically, FIG. 9A illustrates a first round of the multiple block ECB mode decryption of the cipher text vector 802 depicted in FIG. 8B.

As shown in FIG. 9A, the parsed cipher text portion 802-1 is independently decrypted using decrypt engine 602-1 to reproduce plain data portion 502-1. The cipher text portion 802-2 is also independently decrypted using decrypt engine 602-2 to reproduce plain data portion 502-2. This process is continued for all but one cipher text portion.

During the first round of decryption, padding is added to the cipher text portion 802-(N−1). Specifically, a padded portion 902 is appended to the cipher text portion 802-(N−1) such that the total length of the cipher text portion 802-(N−1) and the padded portion 902 is equal to one data chunk of the decrypt engine 602-(N−1). The length of the padded portion 902 is equal to the length of the padded portion 512 appended to the plain data portion 512-N. The length of the padded portion 902 can be determined since the length of the cipher text vector 802 is known. The cipher text portion 802-(N−1) and appended padded portion 902 are then decrypted using the decrypt engine 602-(N−1) to produce an unknown or undesirable result 904. The unknown result 904 is an irrelevant portion not equal to the plain data portion 502-(N−1).

The last step of the first round of the decryption operation involves the decryption of the cipher text portion 802-N. The cipher text portion 802-N is decrypted using decrypt engine 602-N to produce intermediate output 906. The intermediate output 906 is XORed with the input from the prior encryption operation (i.e., the cipher text portion 802-(N−1) and appended padded portion 902) to produce an output 908. In essence, the output 908 is generated by mimicking a CBC mode of decryption. The output 908 can be considered an output portion succeeding the irrelevant portion 904. The output 908 includes the reproduced plain data portion 502-N and the extraneous portion 806. As shown in FIG. 9A, the first round of decryption is concluded when the extraneous portion 806 is used to overwrite the padded portion 902. At the conclusion of the first round, each portion of the plain data vector 502 is recovered with the exception of the plain data portion 502-N−1).

FIG. 9B illustrates a workflow 900-B according to an aspect of the present invention for conducting a second round of ECB block cipher descrambling of cipher text having a length that is longer than a data chunk and not equal to a multiple of the data chunk. Specifically, FIG. 9B illustrates a second round of the multiple block CBC mode decryption of the cipher text vector 802 depicted in FIG. 8B.

The second round of decryption is used to recover the plain data portion 502-(N−1). As shown in FIG. 9B, the extraneous portion 806 is appended to the cipher text portion 802-(N−1). Together, the extraneous portion 806 and the cipher text portion 802-(N−1) are provided to the decrypt engine 602-(N−1) to reproduce 502-(N−2). The plain data portions 502-1 through 502-N are then concatenated to produce plain data vector 502 as illustrated in FIG. 5A.

The combination of the cipher text portion 802-(N−1) and the extraneous portion 806 is used to reproduce the plain data portion 502-(N−1). The extraneous portion 806, however, is not available to the decrypt engine 602-(N−1) during the first round of decryption. Specifically, the extraneous portion 806 is reproduced only after decrypting the last cipher text portion 506-N. Therefore, a second round of decryption is used to decrypt the combination of the cipher text portion 802-(N−1) and the extraneous portion 806. Since all other portions of the plain data vector 502 are recovered in the first round of decryption, it is not necessary to conduct any other decryption operations in the second round.

The extraneous portion 806 is not directly carried in the encrypted payload 802. The extraneous portion 806, however, is indirectly carried by the encryption payload 802. The extraneous portion 806 is indirectly carried due to the XORing of the cipher text portion 804 with the plain data portion 502-N and the padded portion 512 as shown in FIG. 8A. The first round of decryption is used to recover the extraneous portion 806. Once recovered, a second round of decryption is used to recover the second to last plain data portion 502-(N−1).

The workflows 900-A and 900-B can be used to fully decrypt any type of cipher text such as, for example, encrypted MPEG data. Together, the workflows 900-A and 900-B provide a termination scheme for data scrambled according to the workflow 800 depicted in FIG. 8A. It is to be appreciated by one skilled in the relevant art(s) from the discussion herein that the workflow 800 and the workflows 900-A and 900-B can accommodate an initialization mode of encrpytion/decrpytion and a generic mode of encryption/decryption, as discussed above in conjunction with the workflows 520, 600-A and 600-B.

Further, the workflows 900-A and 900-B can be implemented with parallel or serial operations.

The workflows 700-A and 700-B depicted in FIGS. 7A and 7B can be used to accommodate the solitary case of ECB mode encryption and decryption, respectively. By definition, ECB mode encryption and decryption does not use an initial vector. Therefore, the initial vector 514 must be defined by the system or user. When the length of the plain data 704 is less than one data chunk, it follows that the MPEG packet includes an AFD that is larger than the plain data 704. A portion of the AFD can therefore be used to define the initial vector 704. For example, when DES or 3DES encryption is implemented, a 64 bit portion of the AFD can be used. Alternatively, when AES encryption is implemented, a 128 bit portion of the AFD can be used.

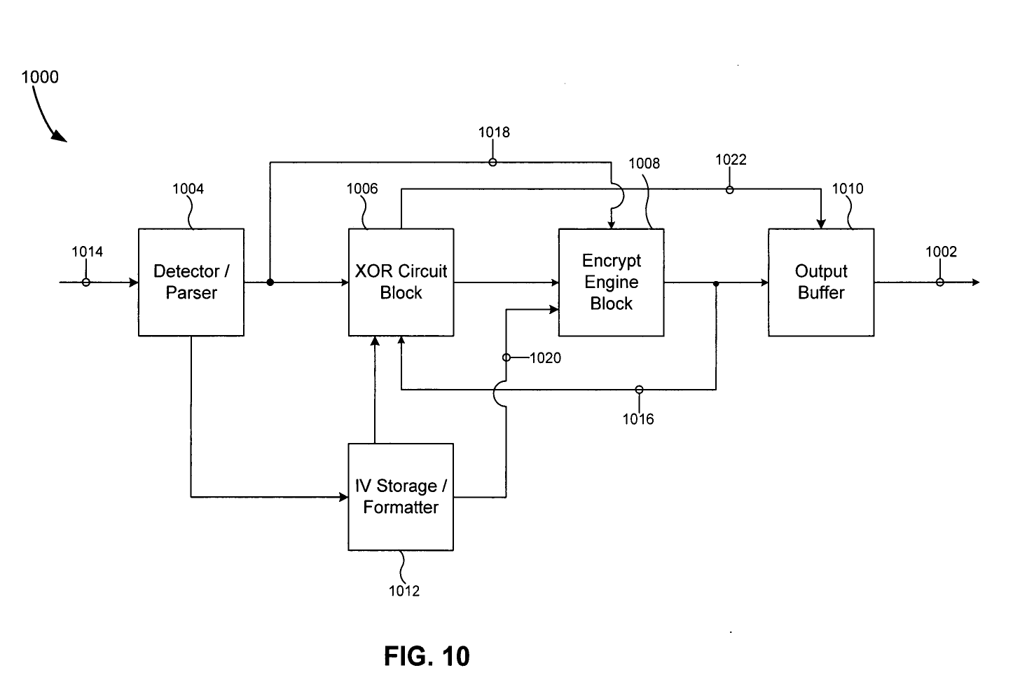

FIG. 10 illustrates an encryption system 1000 according to an aspect of the present invention for encrypting a received plain data vector having a length that is not equal to a multiple of a data chunk. The encryption system 1000 produces a fully encrypted cipher text vector 1002 having a length equal to the length of the original plain data vector. The plain data vector can have a variable length. That is, the plain data vector can be shorter than one data chunk or longer than one data chunk. Overall, the encryption system 1000 is a multi-mode encryption system configured to implement the signal processing shown by workflow 520 depicted in FIG. 5B, workflow 700-A depicted in FIG. 7A or workflow 800 depicted in FIG. 8A.

As shown in FIG. 10, the encryption system 1000 includes a detector/parser 1004, an XOR circuit block 1006, an encrypt engine block 1008, an output buffer 1010 and an initial vector storage/formatter 1012. The parser 1004 receives a transmission packet 1014. The transmission packet 1014 includes an unencrypted payload (i.e., a plain data vector). The transmission packet 1014 can be an MPEG transport stream packet.

The parser 1004 isolates the unencrypted payload of the transmission packet 1014. The parser 1004 also determines the size or length of the unencrypted payload. The operation of the encryption system 1000 varies according to the size of the unencrypted payload. Specifically, the encryption system 1000 implements the signal processing depicted in workflow 520 or the workflow 800 when the length of the plain data vector is longer than one data chunk and implements the signal processing depicted in the workflow 700-A when the plain data vector is shorter than one data chunk. The encryption system 1000 implements the workflow 520 when operating in CBC mode and implements the workflow 800 when operating in ECB mode. The encrypt engine block 1008 can be configured to implement multiple encryption/decryption algorithms such as, for example, DES, 3DES and AES.

When implementing the workflow 520, the parser 1004 slices the plain data vector into N portions and pads the Nth input portion as shown in FIG. 5B. Each portion is passed to the XOR block 1006 and then to the encrypt engine 1008. The first portion is XORed with an initial vector stored in the IV block 1012. All other portions are XORed with the previous output of the encrypt engine 1008 using a feedback connection 1016. After encryption, each portion is provided to the output storage buffer 1010. The output buffer 1010 stores each output portion generated by the encrypt engine 1008. Further, the output buffer 1010 assembles the output of the encrypt engine according to FIG. 5B.

When implementing the workflow 800, the parser 1004 also slices the plain data vector into N portions and pads the Nth input portion as shown in FIG. 8A. Further, a feed forward connection 1018 is used to bypass the XOR block 1006. Specifically, all portions of the plain data vector except the Nth portion are directly passed to the encrypt engine 1008 and then on to the output buffer 1010. The Nth input portion, however, does not bypass the XOR block. Instead, the Nth input portion is XORed with the previous output of the encrypt engine 1008 and then encrypted as shown in FIG. 8A.

When implementing the workflow 700-A, the initial vector stored in the IV block 1012 is passed to the encrypt engine 1008 using a connection 1020. The encrypted initial vector is then passed to the XOR block 1006 using the feedback connection 1016. The XOR block 1006 combines the output of the encrypt engine 1008 with the plain data vector provided by the parser 1004. The output of the XOR block 1006 is then passed to the output buffer 1010 using a connection 1022.

When implementing the workflow 700-A under ECB mode, the IV block 1012 can be used to format a portion of the received transmission packet 1014 for use as an initial vector. For example, the ADF of an MPEG transmission stream packet can be passed to the IV block 1012 from the parser 1004 for appropriate formatting.

The encryption system 1000 is not limited to the embodiment depicted in FIG. 10. Rather, it will be apparent to persons skilled in the relevant art(s) from the teachings herein that other embodiments capable of performing the signal processing functions described herein (e.g., XOR circuits and encrypt engines) are within the scope and spirit of the present invention. Accordingly, it is to be understood that each component of the encryption system 1000 can be implemented in hardware, software or some combination thereof. For instance, the signal processing functions performed by the encryption system 1000 can be implemented using computer processors, computer logic, Application Specific Integrated Circuits (ASICs), digital signal processors, etc., as will be understood by those skilled in the art(s) based on the discussion herein. Specifically, in one embodiment, the constituent components of the encryption system 1000 are each hardware devices comprising an ASIC and are controlled by a software driver or system. Overall, any processor that performs the signal processing functions described herein is within the scope and spirit of the present invention.

Further, the signal processing functions described herein in relation to FIG. 10 could be embodied by computer program instructions that are executed by a computer processor or any one of the hardware devices listed above. The computer program instructions cause the processor to perform the signal processing functions described herein. The computer program instructions (e.g., software) can be stored in a computer usable medium, computer program medium, or any storage medium that can be accessed by a computer or processor. Such media include a memory device such as a RAM or ROM, or other type of computer storage medium such as a computer disk or CD ROM, or the equivalent. Accordingly, any computer storage medium having computer program code that cause a processor to perform the signal processing functions described herein are within the scope and spirit of the present invention.

Additionally, it is to be understood that the constituent components and supporting interconnections of the encryption system 1000 can be configured to process portions of a received plain data vector in a serial fashion or in a parallel fashion. For parallel processing of multiple portions of a plain data vector, the XOR block 1006 and the encryption engine block 1008 can include one or more XOR circuits and encryption engines, respectively.

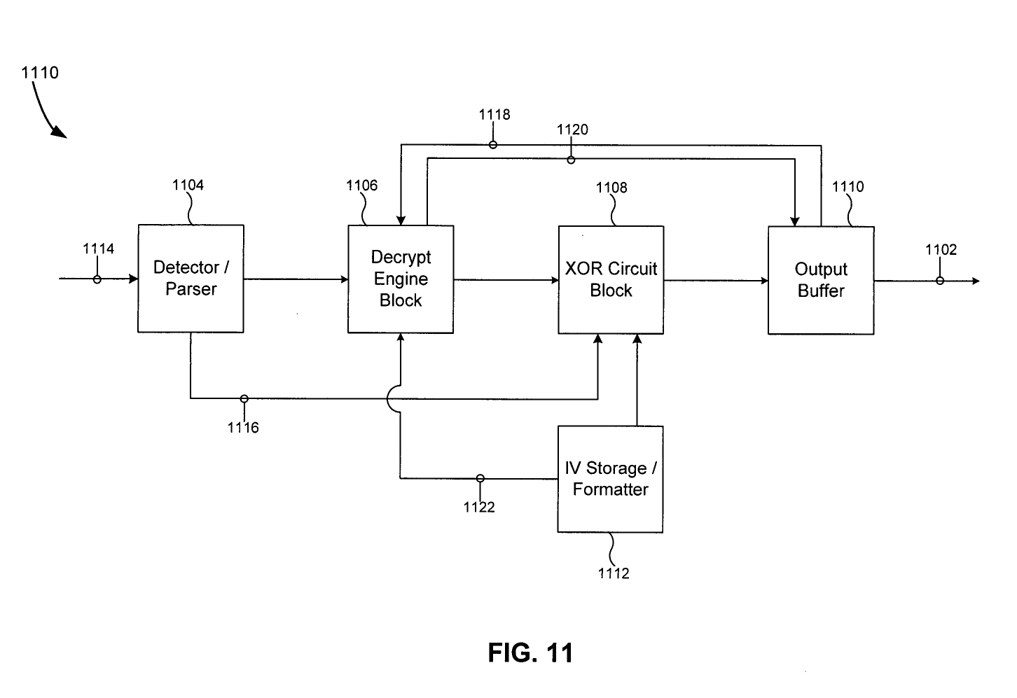

FIG. 11 illustrates an decryption system 1100 according to an aspect of the present invention for decrypting a received cipher text vector (encrypted data) having a length that is not equal to a multiple of a data chunk. The decryption system 1100 produces a decrypted plain data vector 1102 having a length equal to the length of the original cipher text vector. The cipher text vector can have a variable length. That is, the cipher text vector can be shorter than one data chunk or longer than one data chunk. Overall, the decryption system 1100 is a multi-mode decryption system configured to implement the signal processing shown by workflows 600-A/B depicted in FIGS. 6A/6B, workflow 700-B depicted in FIG. 7B or workflows 900-A/B depicted in FIGS. 9A/9B.

As shown in FIG. 11, the decryption system 1100 includes a detector/parser 1104, a decrypt engine block 1106, an XOR circuit block 1108, an output buffer 1110 and an initial vector storage/formatter 1112. The parser 1104 receives a transmission packet 1114. The transmission packet 1114 includes an encrypted payload (i.e., a cipher text vector). The transmission packet 1114 can be an MPEG transmission stream packet.

The parser 1104 isolates the encrypted payload of the transmission packet 1114. The parser 1104 also determines the size or length of the encrypted payload. The operation of the decryption system 1100 varies according to the size of the encrypted payload. Specifically, the decryption system 1100 implements the signal processing depicted in the workflows 600-A/B or the workflows 900-A/B when the length of the cipher text vector is longer than one data chunk and implements the signal processing depicted in the workflow 700-B when the cipher text vector is shorter than one data chunk. The decryption system 1100 implements the workflows 600-A/B when operating in CBC mode and implements the workflows 900-A/B when operating in ECB mode. The decrypt engine block 1106 can be configured to implement multiple encryption/decryption algorithms such as, for example, DES, 3DES and AES.

When implementing the workflow 600-A, the parser 1104 slices the cipher text vector into N portions and pads the N−1 input portion as shown in FIG. 6A. Each portion is passed to the decrypt block 1106 and then to the XOR block 1108. The first portion is XORed with an initial vector stored in the IV block 1112. All other portions are XORed with the previous input to the decrypt engine 1106 using the connection 1116. The parser 1104 can include storage for holding and then forwarding the appropriate portions of the cipher text vector to the XOR block 1108. After decryption, each portion is provided to the output storage buffer 1110. The output buffer 1110 stores each output portion generated by the XOR block 1108. Further, the output buffer 1110 assembles the output of the XOR block 1108 according to FIG. 5C. Every portion of the resulting decrypted plain data vector 1102 except the N−1 output portion is generated during the first round of decryption.

When implementing the workflow 600-B, the output buffer 1110 provides a portion of the Nth decrypted output portion to the decrypt engine 1106 using the connection 1118. The decrypt engine 1106 and XOR block 1108 perform the second round of decryption on the N−1 input portion as illustrated in FIG. 6B. The output buffer 1110 concludes the second round of decryption by appropriately placing the N−1 output portion into the plain data vector as shown in FIG. 5C.

When implementing the workflow 900-A, the parser 1104 also slices the cipher text vector into N portions and pads the N−1 input portion as shown in FIG. 9A. Further, a feed forward connection 1020 is used to bypass the XOR block 1108. Specifically, all portions of the cipher vector except the Nth portion are directly passed to the output buffer 1110 after decryption by the decrypt engine 1106. The Nth input portion, however, does not bypass the XOR block 1108. Instead, the Nth input portion is XORed with the previous input to the decrypt engine 1106 (using the connection 1116) and then decrypted as shown in FIG. 9A. The workflow 900-B mimics the workflow 600-B discussed above.

When implementing the workflow 700-B, the initial vector stored in the IV block 1112 is passed to the decrypt engine 1106 using a connection 1122. The decrypted initial vector is then passed to the XOR block 1108. The XOR block 1108 combines the output of the decrypt engine 1106 with the cipher text vector provided by the parser 1104 using the connection 1116. The output of the XOR block 1108 is then passed to the output buffer 1110.

When implementing the workflow 700-B under ECB mode, the IV block 1112 can be used to format a portion of the received transmission packet 1114 for use as an initial vector. For example, the ADF of an MPEG transmission stream packet can be passed to the IV block 1112 from the parser 1104 for appropriate formatting.

The decryption system 1100 is not limited to the embodiment depicted in FIG. 11. Rather, it will be apparent to persons skilled in the relevant art(s) from the teachings herein that other embodiments capable of performing the signal processing functions described herein (e.g., XOR circuits and decrypt engines) are within the scope and spirit of the present invention. Accordingly, it is to be understood that each component of the decryption system 1100 can be implemented in hardware, software or some combination thereof. For instance, the signal processing functions performed by the decryption system 1100 can be implemented using computer processors, computer logic, ASICs, digital signal processors, etc., as will be understood by those skilled in the art(s) based on the discussion herein. Specifically, in one embodiment, the constituent components of the decryption system 1100 are each hardware devices comprising an ASIC and are controlled by a software driver or system. Overall, any processor that performs the signal processing functions described herein is within the scope and spirit of the present invention.

Further, the signal processing functions described herein in relation to FIG. 11 could be embodied by computer program instructions that are executed by a computer processor or any one of the hardware devices listed above. The computer program instructions cause the processor to perform the signal processing functions described herein. The computer program instructions (e.g., software) can be stored in a computer usable medium, computer program medium, or any storage medium that can be accessed by a computer or processor. Such media include a memory device such as a RAM or ROM, or other type of computer storage medium such as a computer disk or CD ROM, or the equivalent. Accordingly, any computer storage medium having computer program code that cause a processor to perform the signal processing functions described herein are within the scope and spirit of the present invention.

Additionally, it is to be understood that the constituent components and supporting interconnections of the decryption system 1100 can be configured to process portions of a received cipher text vector in a serial fashion or in a parallel fashion. For parallel processing of multiple portions of a cipher text vector, the XOR block 1108 and the decryption engine block 1106 can include one or more XOR circuits and decryption engines, respectively.

The encryption system 1000 and the decryption system 1100 can be used to securely transport digital information. For example, the encryption system 1000 can be used to encrypt digital media so that the encrypted digital media can be provided to desired end-users. Accordingly, the decryption system 1100 can be used by a desired end-user to decrypt the received encrypted digital media. Specifically, the decryption system 1100 can comprise a portion of a digital cable or satellite television “set-top” box.

### Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

While various embodiments of the present invention have been described above, it should be understood that they have been presented by way of example and not limitation. It will be apparent to one skilled in the pertinent art that various changes in form and detail can be made therein without departing from the spirit and scope of the invention. Therefore, the present invention should only be defined in accordance with the following claims and their equivalents.

What is claimed is:

1. A method for encrypting data comprising one or more complete input portions having lengths equal to a data chunk of an encrypt engine and a partial input portion having a length less than the data chunk, the method comprising the steps of:
padding the partial input portion with a padding portion such that the length of the partial input portion is equal to the data chunk;
encrypting the input portions to produce corresponding output portions;
discarding an extraneous portion of an output portion corresponding to a complete input portion preceding the partial input portion, wherein a length of the extraneous portion is equal to a length of the padding portion; and
concatenating the output portions to produce an encrypted vector, wherein a length of the encrypted vector is equal to a length of the data.

2. The method of claim 1, wherein padding the partial input portion comprises appending the padding portion to the partial input portion.

3. The method of claim 1, wherein encrypting the input portions comprises encrypting the input portions according to a block cipher algorithm.

4. The method of claim 3, wherein encrypting the input portions comprises encrypting the input portions according to a Cipher Block Chaining (CBC) mode of the block cipher algorithm.

5. The method of claim 3, wherein encrypting the input portions comprises encrypting the one or more complete input portions according to an Electronic Codebook (ECB) mode of the block cipher algorithm and encrypting the partial input portion according to a Cipher Block Chaining (CBC) mode of the block cipher algorithm.

6. The method of claim 1, further comprising receiving a Moving Picture Experts Group (MPEG) transport stream packet containing the data.

7. A method for decrypting encrypted data comprising one or more complete input portions having lengths equal to a data chunk of a decrypt engine and a partial input portion having a length less than the data chunk, the method comprising:
conducting a first round of decryption on the one or more complete input portions and the partial input portion to produce corresponding output portions and a corresponding irrelevant output portion, respectively, wherein an output portion succeeding the irrelevant output portion comprises a relevant section and an extraneous section;
conducting a second round of decryption on a modified partial input portion to produce a modified output portion; and
concatenating the output portions with the modified output portion and the relevant section to produce a decrypted data vector, wherein a length of the decrypted data vector is equal to a total length of the encrypted data.

8. The method of claim 7, further comprising parsing the encrypted data into the one or more complete input portions and the partial input portion.

9. The method of claim 7, further comprising padding the partial input portion with a padding portion such that the length of the partial input portion is equal to the data chunk.

10. The method of claim 9, wherein padding the partial input portion comprises appending the padding portion to the partial input portion.

11. The method of claim 9, further comprising replacing the padding portion with the extraneous section to form the modified partial input portion.

12. The method of claim 7, wherein conducting the first and second rounds of decryption comprises conducting the first and second rounds of decryption according to a block cipher algorithm.

13. The method of claim 12, wherein conducting the first and second rounds of decryption comprises decrypting the one or more complete input portions, the partial input portion and the modified partial input portion according to a Cipher Block Chaining (CBC) mode of the block cipher algorithm.

14. The method of claim 12, wherein conducting the first and second rounds of decryption comprises:
decrypting the partial input portion, the modified partial input portion and the one or more complete input portions other than a complete input portion succeeding the partial input portion according to an Electronic Codebook (ECB) mode of the block cipher algorithm; and
decrypting the complete input portion succeeding the partial input portion according to a Cipher Block Chaining (CBC) mode of the block cipher algorithm.

15. The method of claim 7, further comprising receiving a Moving Picture Experts Group (MPEG) transport stream packet containing the encrypted data.

16. A method for encrypting data having a length less than a data chunk of a encrypt engine, comprising:
encrypting an initial vector having a length equal to the data chunk to produce an intermediate output; and
combining the data and the intermediate output to produce an encrypted output having a relevant portion and an extraneous portion, wherein a length of the relevant portion is equal to the length of the data.

17. The method of claim 16, wherein encrypting the initial vector comprises encrypting the initial vector according to a block cipher algorithm.

18. The method of claim 16, wherein combining the data and the intermediate output comprises XORing the data with the intermediate output.

19. The method of claim 16, further comprising receiving a Moving Picture Experts Group (MPEG) transport stream packet containing the data.

20. The method of claim 19, further comprising forming the initial vector from a portion of an Adaptation Field (ADF) of the MPEG transport stream packet.

21. A method for decrypting encrypted data having a length less than a data chunk of a decrypt engine, comprising:
decrypting an initial vector having a length equal to the data chunk to produce an intermediate output; and
combining the encrypted data and the intermediate output to produce a decrypted output having a relevant portion and an extraneous portion, wherein a length of the relevant portion is equal to the length of the encrypted data.

22. The method of claim 21, wherein decrypting the initial vector comprises decrypting the initial vector according to a block cipher algorithm.

23. The method of claim 21, wherein combining the encrypted data and the intermediate output comprises XORing the encrypted data with the intermediate output.

24. The method of claim 21, further comprising receiving a Moving Picture Experts Group (MPEG) transport stream packet containing the encrypted data.

25. The method of claim 24, further comprising forming the initial vector from a portion of an Adaptation Field (ADF) of the MPEG transport stream packet.

26. A multiple mode decryption system to decrypt encrypted data having a length not equal to a multiple of a data chunk of the multiple mode decryption system, the system comprising:
a parser;
a decrypt engine coupled to the parser, an input size of the decrypt engine equal to the data chunk;
an XOR circuit coupled to the parser and the decrypt engine; and
an output buffer coupled to the XOR circuit and the decrypt engine, wherein the output buffer produces a decrypted version of the encrypted data having a length equal to a length of the encrypted data under a first, second, and third mode of operation of the multiple mode decryption system.

27. The system of claim 26, wherein the parser parses the encrypted data into one or more complete input portions having lengths equal to the data chunk and a partial input portion having a length less than the data chunk under the first and second modes of operation.

28. The system of claim 27, wherein the parser pads the partial input portion using a padding portion such that the length of the partial input portion is equal to the data chunk.

29. The system of claim 28, wherein the decrypt engine and the XOR circuit conduct a first round of decryption on the one or more complete input portions and the partial input portion to produce corresponding output portions and a corresponding irrelevant output portion, respectively, wherein an output portion succeeding the irrelevant output portion comprises a relevant section and an extraneous section.

30. The system of claim 29, wherein the decrypt engine and the XOR circuit conduct a second round of decryption on a modified partial input portion to produce a modified output portion.

31. The system of claim 30, wherein the padding portion is replaced with the extraneous portion to form the modified partial input portion.

32. The system of claim 30, wherein the decrypt engine and XOR circuit decrypt the one or more complete input portions, the partial input portion and the modified partial input portion according to a Cipher Block Chaining (CBC) mode of a block cipher algorithm.

33. The system of claim 30, wherein the decrypt engine and XOR circuit decrypt the partial input portion, the modified partial input portion and the one or more complete input portions other than a complete input portion succeeding the partial input portion according to an Electronic Codebook (ECB) mode of a block cipher algorithm.

34. The system of claim 33, wherein the decrypt engine and XOR circuit decrypt the complete input portion succeeding the partial input portion according to a Cipher Block Chaining (CBC) mode of the block cipher algorithm.

35. The system of claim 30, wherein the output buffer concatenates the output portions with the modified output portion and the relevant portion to form the decrypted version of the encrypted data.

36. The system of claim 26, wherein the parser parses the encrypted data into one input portion under the third mode of operation, the one input portion having a length less than the data chunk.

37. The system of claim 36, wherein the decrypt engine decrypts a known initial vector to produce an intermediate output.

38. The system of claim 37, wherein the XOR circuit combines the intermediate output with the encrypted data to form the decrypted version of the encrypted data.

39. The system of claim 26, wherein the encrypted data comprises a portion of a Moving Picture Experts Group (MPEG) transport stream packet.
